(19) United States
(12) Patent Application Publication
(10) Pub. No.: US 2011/0128201 A1
(43) Pub. Date: Jun. 2, 2011

(54) CIRCULARLY POLARIZED ANTENNA IN WIRELESS COMMUNICATION SYSTEM AND METHOD FOR MANUFACTURING THE SAME

(75) Inventors: Jeong-Ho JU, Seoul (KR); Jae-Ick Choi, Daejeon (KR); Wangjoo Lee, Daejeon (KR); Dong-Ho Kim, Daejeon (KR)

(73) Assignee: ELECTRONICS AND TELECOMMUNICATIONS RESEARCH INSTITUTE, Daejeon (KR)

(21) Appl. No.: 12/953,124

(22) Filed: Nov. 23, 2010

(30) Foreign Application Priority Data
Nov. 30, 2009 (KR) 10-2009-0117392
Nov. 30, 2009 (KR) 10-2009-0117456

(51) Int. Cl. H01Q 11/14; H01P 11/00

(52) U.S. Cl. 343/756; 29/600

(57) ABSTRACT

A circularly polarized antenna in a wireless communication system includes: at least one feed antenna positioned at a predetermined point on at least one ground substrate; and a unit antenna having a plurality of conductive structures arranged in a predetermined identical direction on a superstrate positioned at a predetermined distance from above the feed antenna. The plurality of conductive structures and the unit antenna are configured to radiate circularly polarized waves, respectively, when the feed antenna radiates linearly polarized waves.

### CROSS-REFERENCES TO RELATED APPLICATIONS

The present application claims priority of Korean Patent Application Nos. 10-2009-0117392 and 10-2009-0117456, filed on Nov. 30, 2009, and Nov. 30, 2009, respectively, which are incorporated herein by reference in their entirety.

### BACKGROUND OF THE INVENTION

1. Field of the Invention

Exemplary embodiments of the present invention relate to a wireless communication system; and, more particularly, to a circularly polarized antenna configured to generate high-gain circularly polarized waves using a superstrate in a wireless communication system and a method for manufacturing the same.

2. Description of Related Art

Various types of antennas have been proposed to transmit/receive signals in wireless communication systems, and patch antennas, among such antennas, have the advantages of compactness, lightness, ease of manufacturing, and inexpensiveness. However, the patch antennas have shortcomings in that it is difficult to increase the bandwidth, and they induce a large amount of coupling loss, making their use in high-frequency bands unfeasible.

Circularly polarized antennas, which have recently been used widely in wireless communication systems, are implemented using patch antennas. Various approaches have been proposed to improve the gain of circularly polarized antennas using patch antennas. Specifically, it has been proposed as an approach to improve the gain circularly polarized antennas using patch antennas that a plurality of patch antennas or a plurality of circularly polarized antennas are arranged so as to increase the number of arrayed antennas which generate circularly polarized waves.

However, the above-mentioned approach of increasing the number of arrayed antennas has a problem in that energy loss resulting from antenna feeding to the arrayed antennas increases in proportion to the number of feeds to respective arrayed antennas, degrading the overall antenna efficiency. Such efficiency degradation requires, in order to obtain suitable gain and axial ratio required of the antenna, detailed adjustment of the length of feeding to respective arrayed antennas, arrangement interval, and the like. This increases the complexity of the antenna and its structure, making implementation of the antenna difficult.

### SUMMARY OF THE INVENTION

An embodiment of the present invention is directed to a circularly polarized antenna having high gain in a wireless communication system and a method for manufacturing the same.

Another embodiment of the present invention is directed to a circularly polarized antenna implemented by patch antennas in a simple structure so as to have high gain in a wireless communication system and a method for manufacturing the same.

Another embodiment of the present invention is directed to a circularly polarized antenna which can be easily designed using a superstrate and a small number of feed antennas so as to have high gain in a wireless communication system and a method for manufacturing the same.

Another embodiment of the present invention is directed to a circularly polarized antenna which can be implemented easily using a superstrate and patch antennas so as to have high gain, while minimizing complexity of the antenna, in a wireless communication system and a method for manufacturing the same.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a circularly polarized antenna in a wireless communication system includes: at least one feed antenna positioned at a predetermined point on at least one ground substrate; and a unit antenna having a plurality of conductive structures arranged in a predetermined identical direction on a superstrate positioned at a predetermined distance from above the feed antenna, wherein the plurality of conductive structures and the unit antenna are configured to radiate circularly polarized waves, respectively, when the feed antenna radiates linearly polarized waves.

In accordance with another embodiment of the present invention, a method for manufacturing a circularly polarized antenna in a wireless communication system includes: arranging a plurality of conductive structures in a predetermined identical direction on a first dielectric substrate positioned at a predetermined distance from above a ground substrate; and forming a feed antenna at a predetermined point on the ground substrate so that the feed antenna has a feed point at a predetermined distance from a center point on the ground substrate, wherein when the ground substrate is shaped to have a y-axis length larger than an x-axis length, the feed antenna radiates y-polarized waves, and the dielectric substrate and the plurality of conductive structures radiate right-handed polarized waves, respectively, and when the ground substrate is shaped to have a y-axis length smaller than an x-axis length, the feed antenna radiates x-polarized waves, and the dielectric substrate and the plurality of conductive structures radiate left-handed polarized waves, respectively.

In accordance with another embodiment of the present invention, a method for manufacturing a circularly polarized antenna in a wireless communication system includes: forming a first dielectric substrate on a ground substrate; forming a feed antenna at a predetermined point on the first dielectric substrate; positioning a second dielectric substrate at a predetermined distance from the ground substrate over the feed antenna; arranging a plurality of conductive structures on the second dielectric substrate in a predetermined identical direction, the conductive structures being shaped by removing symmetric corners of quadrilateral patches to be parallel to each other, the symmetric corners facing each other in a diagonal direction; and successively arranging a plurality of second dielectric substrates so as to have a predetermined phase difference, the plurality of conductive structures being arranged on the second dielectric substrates, wherein when the feed antenna radiates x-polarized waves, the plurality of conductive structures, the second dielectric substrate on which the plurality of conductive structures are arranged, and the plurality of successively arranged second dielectric substrates radiate left-handed polarized waves, respectively; when the feed antenna radiates y-polarized waves, the plurality of conductive structures, the second dielectric substrate on which the plurality of conductive structures are arranged, and the plurality of successively arranged second dielectric substrates radiate right-handed polarized waves, respectively; in said successively arranging a plurality of second dielectric substrates so as to have a predetermined phase difference, the plurality of conductive structures being arranged on the second dielectric substrates, a plurality of second dielectric substrates positioned over the feed antenna configured to radiate the x-polarized waves or the y-polarized waves are arranged successively so as to have a phase difference of 0°, 90°, 180°, and 270°; and in said forming a feed antenna at a predetermined point on the first dielectric substrate, the feed antenna configured to radiate the x-polarized waves or the y-polarized waves is formed at a predetermined point on the first dielectric substrate so as to have a feed point at a predetermined distance from a center point on the first dielectric substrate shaped to have a y-axis length different from an x-axis length.

### BRIEF DESCRIPTION OF THE DRAWINGS

FIG. 1 schematically illustrates a conductive structure of a circularly polarized antenna in a wireless communication system in accordance with an embodiment of the present invention.

FIG. 2 illustrates a schematic upper structure of a unit antenna of a circularly polarized antenna in a wireless communication system in accordance with an embodiment of the present invention.

FIG. 3 schematically illustrates a unit antenna structure of a circularly polarized antenna in a wireless communication system in accordance with an embodiment of the present invention.

FIGS. 4A and 4B schematically illustrate feed antenna structures of circularly polarized antennas in a wireless communication system in accordance with embodiments of the present invention.

FIGS. 5 and 6 schematically illustrate feed antenna structures of circularly polarized antennas configured to radiate double circularly polarized waves in a wireless communication system in accordance with embodiments of the present invention.

FIGS. 7 and 8 are graphs showing the S-parameter of a circularly polarized antenna in accordance with an embodiment of the present invention.

FIG. 9 is a graph showing the axial ratio of a circularly polarized antenna, in connection with S-parameter, in a wireless communication system in accordance with an embodiment of the present invention.

FIGS. 10 and 11 are graphs showing the gain and axial ratio of left-handed polarized waves and right-handed polarized waves of a circularly polarized antenna in a wireless communication system in accordance with an embodiment of the present invention.

FIGS. 12 and 13 are graphs showing the gain and axial ratio of double circularly polarized waves of a circularly polarized antenna in a wireless communication system in accordance with an embodiment of the present invention.

FIG. 14 schematically illustrates a process of manufacturing a circularly polarized antenna in a wireless communication system in accordance with an embodiment of the present invention.

FIG. 15 schematically illustrates an arrayed antenna structure of a circularly polarized antenna in a wireless communication system in accordance with another embodiment of the present invention.

FIGS. 16 and 17 schematically illustrate the arrangement structure of arrayed antennas of a circularly polarized antenna in a wireless communication system in accordance with another embodiment of the present invention.

FIGS. 18 and 19 are graphs showing the axial ratio and gain of a unit antenna of a circularly polarized antenna in a wireless communication system in accordance with another embodiment of the present invention.

FIGS. 20 and 21 are graphs showing the axial ratio and gain of an arrayed antenna of a circularly polarized antenna in a wireless communication system in accordance with another embodiment of the present invention.

FIG. 22 schematically illustrates a process of manufacturing a circularly polarized antenna in a wireless communication system in accordance with another embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present invention proposes a high-gain circularly polarized antenna in a wireless communication system and a method for manufacturing the same. In accordance with an embodiment of the present invention, a plurality of patches, specifically periodically arranged conductive structures, are attached over a feed antenna including a ground surface, thereby implementing a circularly polarized antenna. In accordance with an embodiment of the present invention, antenna structures having a plurality of patches attached over a feed antenna including a ground surface are arranged successively to implement a circularly polarized antenna. The plurality of patches (i.e. conductive structures) of the circularly polarized antenna generate circularly polarized waves, and periodic arrangement of the conductive structures improves gain of the circularly polarized antenna formed by such arrangement. Depending on polarized waves radiated from the feed antenna, left-handed polarized waves, right-handed polarized waves, or double circularly polarized waves are implemented. Successive arrangement of the arranged conductive structures and the feed antennas improves the antenna's gain, axial ratio, and 3 dB axial-ratio bandwidth.

In accordance with an embodiment of the present invention, a high-gain circularly polarized arrayed antenna using a superstrate is proposed. Specifically, a plurality of conductive structures configured to generate circularly polarized waves, i.e. a plurality of patches, are arranged in a specific shape and at a specific interval and positioned over a feed antenna including a ground surface, thereby implementing a high-gain circularly polarized antenna. Furthermore, in accordance with an embodiment of the present invention, the plurality of conductive structures arranged on the superstrate of the feed antenna radiate left-handed polarized waves or right-handed polarized waves are radiated depending on characteristics of linearly polarized waves generated from the feed antenna, and also radiate left-handed polarized waves, right-handed polarized waves, or double circularly polarized waves depending on the feed antenna.

In accordance with an embodiment of the present invention, the fact that a single feed antenna is used to radiate circularly polarized waves minimizes loss resulting from the feed line, which is used by conventional arrayed antenna structures to improve antenna gain. Therefore, in accordance with an embodiment of the present invention, the simplified feed line for feeding the circularly polarized antenna minimizes the overall antenna complexity, makes antenna design easy, and improves antenna efficiency. In accordance with an embodiment of the present invention, left-handed polarized waves, right-handed polarized waves, or double circularly polarized waves are easily implemented depending on circularly polarized wave characteristics of the feed antenna, which generates linearly polarized waves in a simple feeding scheme so as to generate circularly polarized waves.

An embodiment of the present invention proposes a high-gain circularly polarized antenna having an upper structure, which includes conductive structures arranged to generate circularly polarized waves, positioned over a feed antenna to generate circularly polarized waves so that, depending on characteristics of linearly polarized waves, i.e. x-polarized waves or y-polarized waves, radiated from the feed antenna, the circularly polarized antenna has characteristics of left-handed polarized waves, right-polarized waves, or double circularly polarized waves. The circularly polarized antenna in accordance with an embodiment of the present invention can be easily implemented using a PCB (Printed Circuit Board), and the fact that the conductive structures are positioned over the antenna makes it possible to design a circularly polarized antenna using a single feed antenna (source), and improves the antenna's efficiency and gain. The circularly polarized antenna in accordance with an embodiment of the present invention can easily radiate left-handed polarized waves, right-handed polarized waves, or double circularly polarized waves, depending on characteristics of linearly polarized waves radiated from the feed antenna, and has a simpler feed structure, compared with conventional circularly polarized arrayed antennas, to acquire high gain. This minimizes design complexity of the circularly polarized antenna and loss of antenna supply power, and maximizes antenna efficiency.

In accordance with an embodiment of the present invention, left-handed polarized waves or right-handed polarized waves are implemented depending on characteristics of linearly polarized waves radiated from the feed antenna. Successive arrangement of the high-gain circularly polarized antenna, which has a superstrate, at a phase difference further improves the antenna's gain, axial ratio, and 3 dB bandwidth of the axial ratio. Therefore, the present invention decreases complexity of the feed line resulting from conventional circularly polarized antennas of arrayed antenna structures using patch antennas and reduces loss resulting from the feed line, thereby improving antenna efficiency. Depending on the direction of successive arrangement of feed antennas, left-handed polarized waves or right-handed polarized waves are implemented.

The high-gain circularly polarized antenna using a superstrate in accordance with an embodiment of the present invention has a structure, which includes a plurality of arranged patches (simply conductive structures), positioned over a feed antenna including a ground surface to radiate circularly polarized waves. Depending on characteristics of linearly polarized waves, i.e. x-polarized waves or y-polarized waves, generated by the feed antenna, the conductive structures generate left-handed polarized waves or right-handed polarized waves, thereby improving antenna gain. The antenna gain increases in proportion to the area of the superstrate, and successive arrangement of four circularly polarized antennas, which include superstrates, respectively, at a phase difference of 90° further improves the antenna's gain, axial ratio, and 3 dB axial-ratio bandwidth. In successively arranging four circularly polarized antennas including respective superstrates, antennas having left-handed polarized waves, based on the feed antenna of the circularly polarized antennas, are aligned counterclockwise, and antennas having right-handed polarized waves are aligned clockwise. That is, successive arrangement of four circularly polarized antennas at a phase difference of 90° counterclockwise and clockwise further improves the antenna's gain, axial ratio, and 3 dB axial-ratio bandwidth.

A circularly polarized antenna in accordance with an embodiment of the present invention uses arrangement different from that of conventional arrayed antennas using patches so that each unit antenna has better gain than that of the patch antennas. As a result, a small number of feed antennas are used to acquire a high-gain circularly polarized antenna. For example, conventional patch antennas have gain of 6 dB, and at least 64 patch antennas need to be arranged to acquire antenna gain of 24 dB. However, a circularly polarized antenna in accordance with an embodiment of the present invention has unit antenna gain of 17 dB, and arrangement of four such unit antennas give high antenna gain of 22.6 dB.

The circularly polarized antenna includes a single feed antenna including a ground surface, and a unit antenna having a structure, which includes conductive structures arranged to form circularly polarized wave characteristics when linearly polarized waves are incident, positioned over the feed antenna. Such a circularly polarized antenna improves both antenna gain and antenna efficiency, and generates left-handed polarized waves or right-handed polarized waves depending on linearly polarized waves from the feed antenna, i.e. x-polarized waves or y-polarized waves. That is, the circularly polarized antenna, which has an array of conductive structures positioned in the upper portion of the antenna, can generate circularly polarized waves by a single feed antenna (source), and improves both efficiency and gain of the antenna.

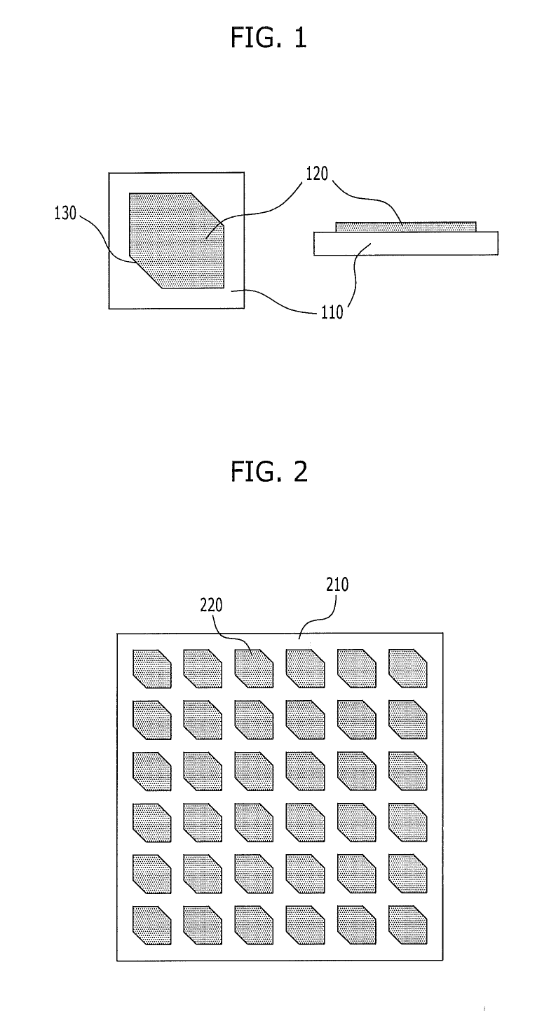

Successive arrangement of high-gain circularly polarized antennas designed in this manner improves the antenna gain, axial ratio, and 3 dB axial-ratio bandwidth. Compared with conventional high-gain circularly polarized successively-arranged antennas, the feed structure is simpler, thereby minimizing antenna design complexity. The resulting circularly polarized antenna minimizes antenna supply power loss, and improves antenna efficiency. In the case of conventional successively arranged antennas, as mentioned above, the gain of respective patch antennas constituting the successively arranged antennas is about 6 dB, which means that 64 respective individual antennas are necessary to obtain high gain of 24 dB. However, the unit antenna, which uses a single feed for respective antennas radiating circularly polarized waves, has gain of 17.05 dB, which means that successive arrangement of only four unit antennas implements high gain of 22.61 dB, thereby improving the axial ratio and 3 dB axial-ratio bandwidth. A circularly polarized antenna in accordance with an embodiment of the present invention will now be described in more detail with reference to FIG. 1.

FIG. 1 schematically illustrates a conductive structure of a circularly polarized antenna in a wireless communication system in accordance with an embodiment of the present invention. Specifically, FIG. 1 illustrates a conductive structure formed on a superstrate of a unit antenna structure configured to both improve antenna gain and implement circularly polarized waves in accordance with an embodiment of the present invention.

Referring to FIG. 1, the conductive structure includes a dielectric substrate 110 made of a predetermined dielectric medium (∈ᵣ) and a conductive plate 120 of a predetermined shape on top of the dielectric substrate 110. The conductive plate 120 serves as a radiation unit of the circularly polarized antenna, and includes circularly polarized wave induction units 130 formed on symmetric corners of the conductive plate 120, which face each other in the diagonal direction, and positioned parallel to each other. The conductive structure may be a patch antenna configured to radiate circularly polarized waves.

The circularly polarized wave induction units 130 are formed by chamfering symmetric corners of the quadrilateral patch, which face each other in the diagonal direction, to be parallel to each other. The conductive plate 120 may have various sizes and shapes depending on the operating frequency, antenna gain, and polarized wave characteristics of the circularly polarized antenna. That is, the conductive structure, when linearly polarized waves are fed, acts as a circularly polarized antenna radiating circularly polarized waves by means of the circularly polarized wave induction units 130. A unit antenna of a circularly polarized antenna in accordance with an embodiment of the present invention will now be described in more detail with reference to FIG. 2.

FIG. 2 illustrates a schematic upper structure of a unit antenna of a circularly polarized antenna in a wireless communication system in accordance with an embodiment of the present invention. Specifically, FIG. 2 illustrates a superstrate structure formed by arranging conductive structures illustrated in FIG. 1 on a superstrate in accordance with an embodiment of the present invention.

Referring to FIG. 2, the unit antenna includes a superstrate 210 and a plurality of conductive structures 220 as illustrated in FIG. 1, specifically a plurality of patches, arranged in a predetermined direction. The superstrate 210 may be the dielectric substrate 110 illustrated in FIG. 1, and the plurality of conductive structures 220, specifically a plurality of patches, are arranged on the superstrate 210 (i.e. dielectric substrate 110) in a predetermined direction.

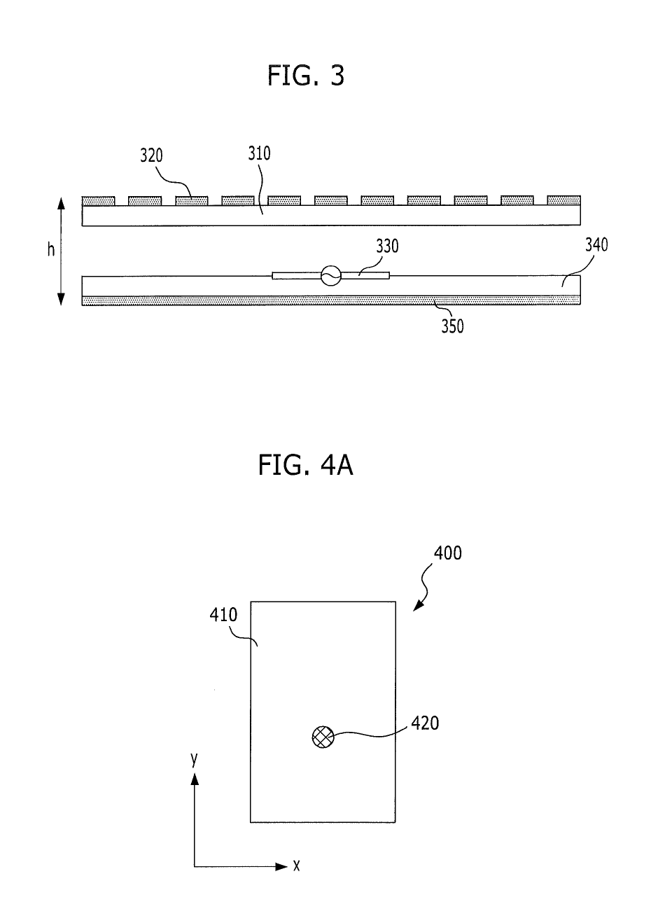

The unit antenna may have a larger size of superstrate 210 to improve antenna gain, and the superstrate 210 may have various shapes, including a rectangle, a square, a circle, an ellipse, a trapezoid, etc. A unit antenna structure of a circularly polarized antenna in accordance with an embodiment of the present invention will now be described in more detail with reference to FIG. 3.

FIG. 3 schematically illustrates a unit antenna structure of a circularly polarized antenna in a wireless communication system in accordance with an embodiment of the present invention.

Referring to FIG. 3, the unit antenna includes a superstrate 310 having a plurality of conductive structures 320, specifically a plurality of patches, arranged thereon as illustrated in FIG. 2, a ground substrate 350 positioned below the superstrate 310 at a predetermined distance (h), a dielectric substrate 340 formed on the ground substrate 350, and a feed antenna 330 formed on the dielectric substrate 340 to feed linearly polarized waves. The superstrate 310 may be the dielectric substrate 110 described with reference to FIG. 1, and the plurality of conductive structures 320 are arranged on the superstrate 310 (dielectric substrate 110) in a predetermined direction.

The feed antenna 330 is spaced from the superstrate 310 so as to indirectly feed the linearly polarized waves to the superstrate 310. Specifically, the unit antenna has predetermined space between the feed antenna 330 and the superstrate 310. The feed antenna 330 performs primary radiation by means of feeding, and the plurality of conductive structures 320 (patches) arranged on the superstrate 310 performs secondary radiation through feeding resulting from the primary radiation. In this case, the feed antenna 330 radiates linearly polarized waves, and the superstrate 310 and the plurality of conductive structures 320 arranged on the superstrate 310 radiate circularly polarized waves. The dielectric substrate 340 formed on the ground substrate 350 is made of dielectric substance having various dielectric constants, including air. The feed antenna 330 may be in any of upper, middle, and lower positions within the structure of the unit antenna.

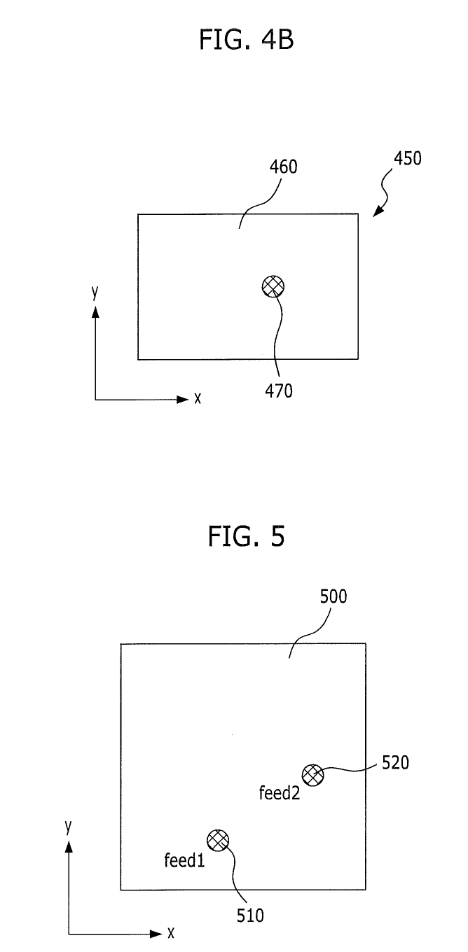

The unit antenna has a single feed antenna 330 configured to perform indirect feeding to a plurality of conductive structures 320, which serve as respective patch antennas. This simplifies the feed structure, makes antenna design easy, minimizes antenna supply power loss, and thus improves antenna efficiency. That is, instead of a plurality of feed antennas corresponding to respective conductive structures 320, the unit antenna employs a single feed antenna 330 to feed all of the plurality of conductive structures 320, thereby reducing complexity of the antenna substantially. Furthermore, arrangement of a plurality of conductive structures 320 on the superstrate 310 increases antenna gain, and circularly polarized waves radiated from the superstrate 310 and from the plurality of conductive structures 320 arranged on the superstrate 310 further increases antenna gain. Feed antennas of circularly polarized antennas in accordance with embodiments of the present invention will now be described in more detail with reference to FIGS. 4A to 6.

FIGS. 4A and 4B schematically illustrate feed antenna structures of circularly polarized antennas in a wireless communication system in accordance with embodiments of the present invention. Specifically, FIGS. 4A and 4B illustrate feed points of feed antennas, which are configured to generate left-handed polarized waves and right-handed polarized waves, of a unit antenna in accordance with embodiments of the present invention, respectively.

Referring to FIGS. 4A and 4B, the circularly polarized antenna includes two types of feeds, specifically first and second feeds 400 and 450, depending on the position of feed points. The first feed 400 includes a dielectric substrate 410 formed on a ground substrate and a feed antenna 420 having a feed point positioned at a predetermined distance from the center point of the dielectric substrate 410. The dielectric substrate 410 of the first feed 400 has a y-axis length larger than its x-axis length, so that the first feed 400 generates y-polarized waves and radiates them to the superstrate.

When the feed antenna 420 radiates y-polarized waves through the first feed 400 in this manner, the superstrate 310 and the plurality of conductive structures 320 arranged on the superstrate 310, which are illustrated in FIG. 3, generates and radiates right-handed polarized waves. Specifically, the unit antenna performs primary radiation of y-polarized waves through the feed antenna 420, and then radiates right-handed polarized waves through feeding of the primary radiation of y-polarized waves. As a result, when the feed antenna 420 generates y-polarized waves through the first feed 400, the unit antenna becomes a circularly polarized antenna radiating right-handed polarized waves.

The second feed 450 includes a dielectric substrate 460 formed on a ground substrate and a feed antenna 470 having a feed point positioned at a predetermined distance from the center point of the dielectric substrate 460. The dielectric substrate 460 of the second feed 450 has a y-axis length smaller than its x-axis length, so that the second feed 450 generates x-polarized waves and radiates them to the superstrate.

When the feed antenna 470 radiates x-polarized waves through the second feed 450 in this manner, the superstrate 310 and the plurality of conductive structures 320 arranged on the superstrate 310, which are illustrated in FIG. 3, generates and radiates left-handed polarized waves. Specifically, the unit antenna performs primary radiation of x-polarized waves through the feed antenna 470, and then radiates left-handed polarized waves through feeding of the primary radiation of x-polarized waves. As a result, when the feed antenna 470 generates x-polarized waves through the second feed 450, the unit antenna becomes a circularly polarized antenna radiating left-handed polarized waves.

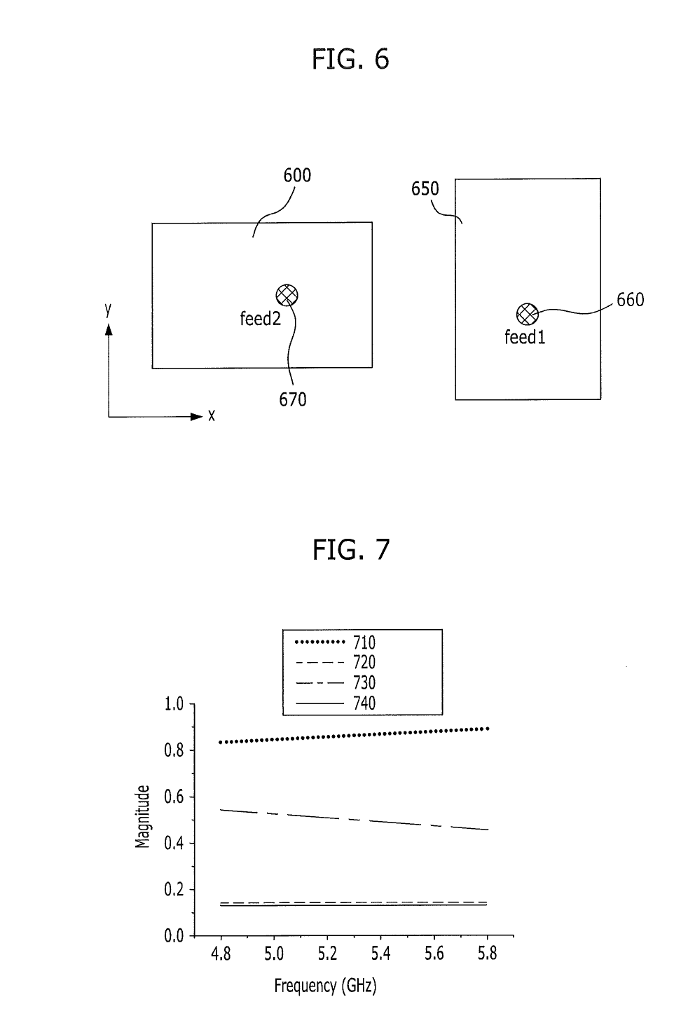

FIGS. 5 and 6 schematically illustrate feed antenna structures of circularly polarized antennas configured to radiate double circularly polarized waves in a wireless communication system in accordance with embodiments of the present invention. Specifically, FIG. 5 illustrates a circularly polarized antenna having a unit antenna including two feed antennas to radiate double circularly polarized waves in accordance with an embodiment of the present invention. FIG. 6 illustrates a circularly polarized antenna having two unit antennas including two feed antennas to radiate double circularly polarized waves in accordance with an embodiment of the present invention.

Referring to FIG. 5, the circularly polarized antenna includes two feed antennas, specifically first and second feed antennas 510 and 520, depending on the position feed points. The first feed antenna 510, as in the case of the above-mentioned first feed 400, has a feed point positioned at a predetermined distance along the y-axis from the center point of a dielectric substrate 500 formed on a ground substrate. As a result, the first feed antenna 510 generates y-polarized waves and radiates them to the superstrate.

When the first feed antenna 510 radiates y-polarized waves in this manner, the superstrate 310 and the plurality of conductive structures 320 arranged on the superstrate 310, which are illustrated in FIG. 3, generates and radiates right-handed polarized waves. Specifically, the unit antenna performs primary radiation of y-polarized waves through the first feed antenna 510, and then radiates right-handed polarized waves through feeding of the primary radiation of y-polarized waves. As a result, when the first feed antenna 510 generates y-polarized waves, the unit antenna becomes a circularly polarized antenna radiating right-handed polarized waves.

The second feed antenna 520 has a feed point positioned at a predetermined distance along the x-axis from the center point of the dielectric substrate 500 formed on a ground substrate. As a result, the second feed antenna 520 generates x-polarized waves and radiates them to the superstrate.

When the second feed antenna 520 radiates x-polarized waves in this manner, the superstrate 310 and the plurality of conductive structures 320 arranged on the superstrate 310, which are illustrated in FIG. 3, generates and radiates left-handed polarized waves. Specifically, the unit antenna performs primary radiation of x-polarized waves through the second feed antenna 520, and then radiates left-handed polarized waves through feeding of the primary radiation of x-polarized waves. As a result, when the second feed antenna 520 generates x-polarized waves, the unit antenna becomes a circularly polarized antenna radiating left-handed polarized waves.

As such, when the first and second feed antennas 510 and 520 radiate y-polarized waves and x-polarized waves, respectively, the circularly polarized antenna radiates both right-hand polarized waves and left-handed polarized waves through the superstrate and the plurality of conductive structures arranged on the superstrate, thereby radiating double circularly polarized waves. In summary, the circularly polarized antenna, which radiates double circularly polarized waves through two feed antennas 510 and 520, is easily implemented in a simple structure while ensuring high gain.

Referring to FIG. 6, the circularly polarized antenna includes different feed points, specifically first and second feed antennas 660 and 670, and first and second unit antennas corresponding to the first and second feed antennas 660 and 670, respectively. The first feed antenna 660, as in the case of the above-mentioned first feed 400, has a feed point positioned at a predetermined distance from the center point of a dielectric substrate 650, which has a y-axis length larger than its x-axis length. As a result, the first feed antenna 660 generates y-polarized waves and radiates them to the superstrate.

When the first feed antenna 660 radiates y-polarized waves in this manner, the superstrate 310 and the plurality of conductive structures 320 arranged on the superstrate 310, which are illustrated in FIG. 3, generates and radiates right-handed polarized waves. Specifically, the unit antenna performs primary radiation of y-polarized waves through the first feed antenna 660, and then radiates right-handed polarized waves through feeding of the primary radiation of y-polarized waves. As a result, when the first feed antenna 660 generates y-polarized waves, the unit antenna becomes a circularly polarized antenna radiating right-handed polarized waves.

The second feed antenna 670, as in the case of the above-mentioned second feed 450, has a feed point positioned at a predetermined distance from the center point of a dielectric substrate 600, which has a y-axis length smaller than its x-axis length. As a result, the second feed antenna 670 generates x-polarized waves and radiates them to the superstrate.

When the second feed antenna 670 radiates x-polarized waves in this manner, the superstrate 310 and the plurality of conductive structures 320 arranged on the superstrate 310, which are illustrated in FIG. 3, generates and radiates left-handed polarized waves. Specifically, the unit antenna performs primary radiation of x-polarized waves through the second feed antenna 670, and then radiates left-handed polarized waves through feeding of the primary radiation of x-polarized waves. As a result, when the second feed antenna 670 generates x-polarized waves, the unit antenna becomes a circularly polarized antenna radiating left-handed polarized waves.

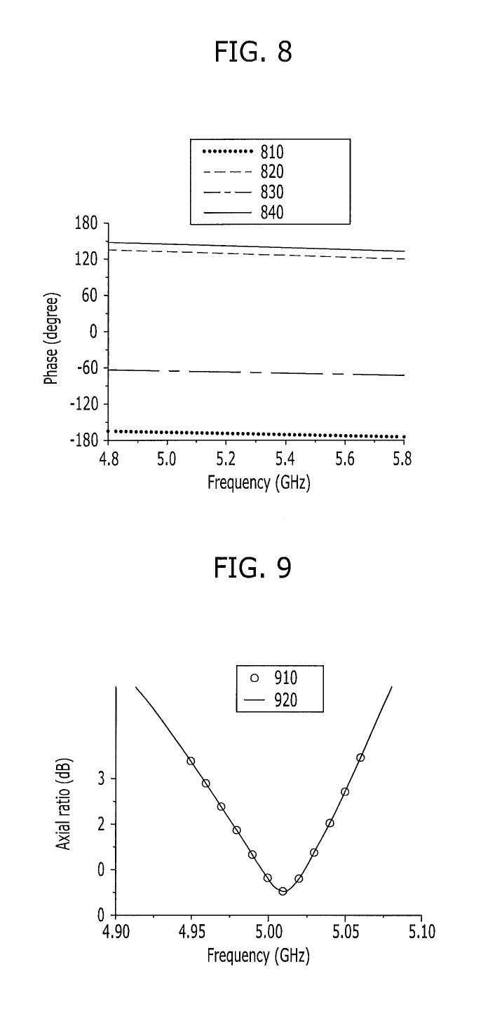

As such, when the first and second feed antennas 660 and 670 radiate y-polarized waves and x-polarized waves, respectively, the circularly polarized antenna radiates both right-hand polarized waves and left-handed polarized waves through the superstrate and the plurality of conductive structures arranged on the superstrate, thereby radiating double circularly polarized waves. In summary, the circularly polarized antenna, which radiates double circularly polarized waves through two unit antennas and two feed antennas 660 and 670, is easily implemented in a simple structure while ensuring high gain. The S (Scattering)-parameter of a circularly polarized antenna in accordance with an embodiment of the present invention will now be described in more detail with reference to FIGS. 7 and 8.

FIGS. 7 and 8 are graphs showing the S-parameter of a circularly polarized antenna in accordance with an embodiment of the present invention. Specifically, FIG. 7 is a frequency-domain graph showing the magnitude of S-parameter of a conductive structure included in a circularly polarized antenna in accordance with an embodiment of the present invention, and FIG. 8 is a frequency-domain graph showing the phase of S-parameter.

Referring to FIGS. 7 and 8, the first graphs 710 and 810 show, when x-polarized waves are applied to a first port, the magnitude and phase of waves which have converted into x-polarized waves at the first port and passed through, respectively. The second graphs 720 and 820 show, when x-polarized waves are applied to the first port, the magnitude and phase of waves which have converted into y-polarized waves at the first port and passed through, respectively. The third graphs 730 and 830 show, when x-polarized waves are applied to the first port, the magnitude and phase of waves which have converted into x-polarized waves at a second port and passed through, respectively. The fourth graphs 740 and 840 show, when x-polarized waves are applied to the first port, the magnitude and phase of waves which have converted into y-polarized waves at the second port and passed through, respectively.

It is clear from FIGS. 7 and 8 that the conductive structure of a circularly polarized antenna in accordance with an embodiment of the present invention radiates circularly polarized waves even if only one type of linearly polarized waves of x-polarized waves or y-polarized waves are applied. The characteristics of circularly polarized waves (e.g. 3 dB axial ratio, bandwidth, axial ratio), resonance frequency, and antenna gain of the circularly polarized antenna depend on the magnitude and phase of the S-parameter of the conductive structure, as well as on the distance (h) between the ground substrate 350 and the superstrate 310, on which the conductive structures are arranged, as illustrated in FIG. 3. The axial ratio of the circularly polarized antenna is calculated using Equations 1 and 2 below.

$$\begin{matrix}{a}_{0} = {e}^{- jφ} , {b}_{0} = {e}^{- jφ} , φ = 2 π l / λ \\ {a}_{n} = {e}^{- j n 2 φ} {e}^{j n π} ( {R}_{x} {a}_{n - 1} + {R}_{y} {b}_{n - 1} ) \\ {b}_{n} = {e}^{- j n 2 φ} {e}^{j n π} ( {R}_{x} {b}_{n - 1} + {R}_{y} {a}_{n - 1} ) & Eq . 1 \\ {E}_{x} = {\sum }_{n = 0}^{∞} ( {T}_{x} {a}_{n} + {T}_{y} {b}_{n} ) \\ {E}_{y} = {\sum }_{n = 0}^{∞} ( {T}_{x} {b}_{n} + {T}_{y} {a}_{n} ) \\ \frac{{E}_{y}}{{E}_{x}} = \pm j & Eq . 2\end{matrix}$$

In Equations 1 and 2 above, l refers to the distance (h) between the ground substrate 350 and the superstrate 310, on which the conductive structures are arranged, as illustrated in FIG. 3; λ refers to the wavelength of signal applied to each port; and Rₓ, Tₓ, R_{y}, T_{y} refer to values of the first to fourth graphs 710, 720, 730, 740, 810, 820, 830, 840 including the magnitude and phase of S-parameter of the conductive structure described above. That is, Rₓ, Tₓ, R_{y}, T_{y} refer to S-parameter values of the conductive structure when x-polarized waves and y-polarized waves are fed.

Consequently, in connection with Equations 1 and 2 above, the circularly polarized antenna radiates left-handed polarized waves when having a value of +j, and radiates right-handed polarized waves when having a value of −j. The circularly polarized antenna radiates left-handed polarized waves when the value of a₀ exists and when the value of b₀ is 0. The circularly polarized antenna radiates right-handed polarized waves when the value of a₀ is 0 and when the value of b₀ exists. The value of a₀ and b₀ is determined in conformity with characteristics of linearly polarized waves from the feed antenna, e.g. x-polarized waves and y-polarized waves, respectively.

That is, when the feed antenna radiates x-polarized waves, the value of a₀ exits, and the value of b₀ becomes 0. As a result, the circularly polarized antenna radiates left-handed polarized waves. When the feed antenna radiates y-polarized waves, the value of a₀ becomes 0, and the value of b₀ exists. As a result, the circularly polarized antenna radiates right-handed polarized waves. The axial ratio, in connection with S-parameter, of a circularly polarized antenna in accordance with an embodiment of the present invention will now be described in more detail with reference to FIG. 9.

FIG. 9 is a graph showing the axial ratio of a circularly polarized antenna, in connection with S-parameter, in a wireless communication system in accordance with an embodiment of the present invention. Specifically, FIG. 9 shows the theoretical value of axial ratio, in frequency domain, of left-handed polarized waves and right-handed polarized waves calculated by substituting the S-parameter value given in FIGS. 7 and 8, as well as the distance (h=29 mm) between the ground substrate 350 and the superstrate 310, on which the conductive structures are arranged, as illustrated in FIG. 3, in Equations 1 and 2 in accordance with an embodiment of the present invention.

Referring to FIG. 9, the circularly polarized antenna radiates left-handed polarized waves, when the linearly polarized waves radiated from the feed antenna are x-polarized waves, and radiates right-handed polarized waves in the case of y-polarized waves, as described above. The axial ratio 910 of left-handed polarized waves and the axial ratio 920 of right-handed polarized waves are obtained when the feed antenna radiates x-polarized waves and y-polarized waves, respectively. The circularly polarized antenna can adjust the S-parameter value by modifying the structure or size of the conductive structures arranged on the superstrate, and the axial ratio and resonance frequency of the circularly polarized antenna can be adjusted according to the S-parameter value, which is adjusted as mentioned above, and the distance (h) between the ground superstrate 350 and the superstrate 310, on which the conductive structures are arranged, as illustrated in FIG. 3. The gain and axial ratio of a circularly polarized antenna in accordance with an embodiment of the present invention will now be described in more detail with reference to FIGS. 10 to 13.

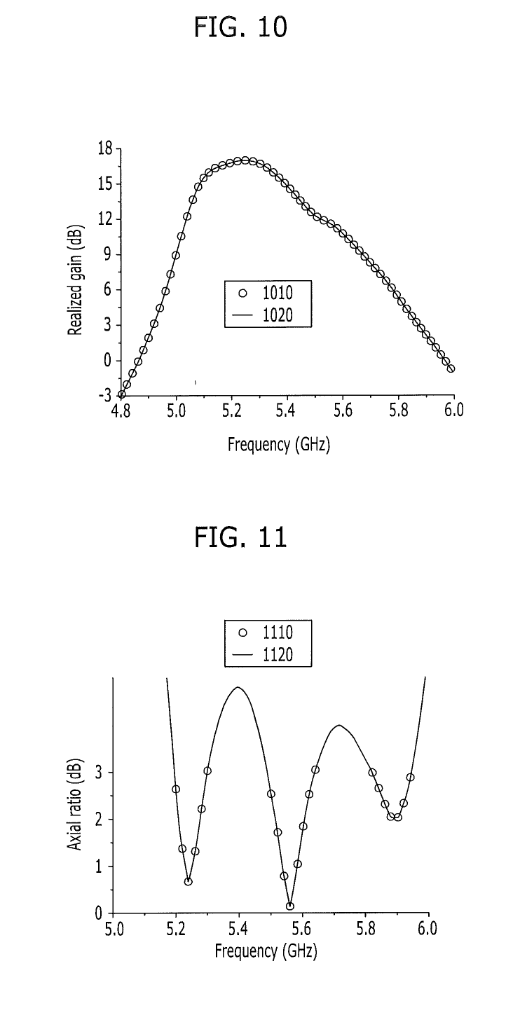

FIGS. 10 and 11 are graphs showing the gain and axial ratio of left-handed polarized waves and right-handed polarized waves of a circularly polarized antenna in a wireless communication system in accordance with an embodiment of the present invention. Specifically, FIG. 10 is a frequency-domain graph showing the realized gain of left-handed polarized waves and right-handed polarized waves radiated from the circularly polarized antenna in accordance with an embodiment of the present invention, and FIG. 11 is a frequency-domain graph showing the axial ratio of left-handed polarized waves and right-handed polarized waves radiated from the circularly polarized antenna in accordance with an embodiment of the present invention.

Referring to FIGS. 10 and 11, the realized gain 1010 of right-handed polarized waves radiated from the circularly polarized antenna, as well as the realized gain 1020 of left-handed polarized waves, have a value of at least 17 dB at 5.24 GHz, which is possible the center frequency. The axial ratio 1110 of right-handed polarized waves radiated from the circularly polarized antenna, as well as the axial ratio 1120 of left-handed polarized waves, have a value of at most 0.5 dB at 5.24 GHz, which is possibly the center frequency. As such, left-handed polarized waves and right-handed polarized waves radiated from the circularly polarized antenna, which has a plurality of conductive structures arranged on the superstrate of the feed antenna, improve the gain and axial ratio of the antenna.

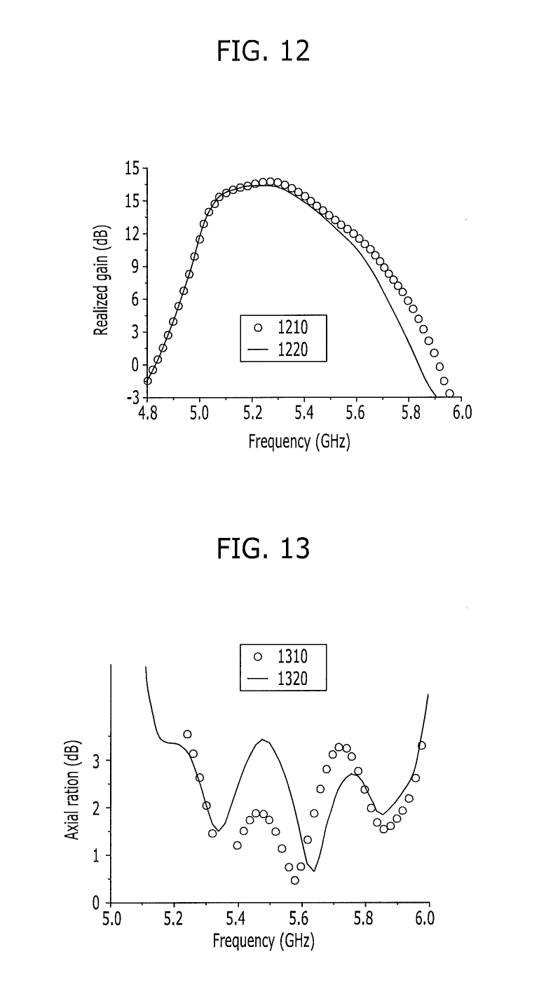

FIGS. 12 and 13 are graphs showing the gain and axial ratio of double circularly polarized waves of a circularly polarized antenna in a wireless communication system in accordance with an embodiment of the present invention. Specifically, FIG. 12 is a frequency-domain graph showing the realized gain of double circularly polarized waves radiated from the circularly polarized antenna in accordance with an embodiment of the present invention, and FIG. 13 is a frequency-domain graph showing the axial ratio of double circularly polarized waves radiated from the circularly polarized antenna in accordance with an embodiment of the present invention.

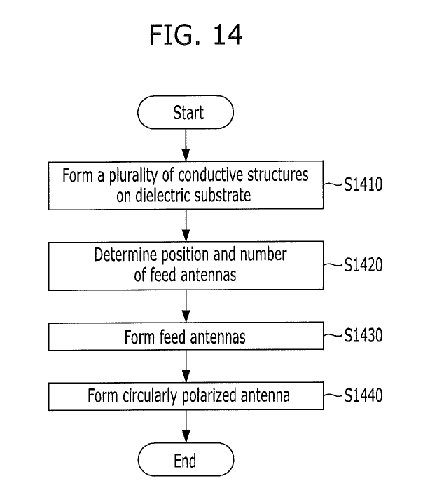

Referring to FIGS. 12 and 13, the circularly polarized antenna radiates double circularly polarized waves, which include right-handed polarized waves and left-handed polarized waves, using a first feed antenna radiating y-polarized waves and a second feed antenna radiating x-polarized waves, as described with reference to FIGS. 5 and 6. The realized gain 1210 of right-handed polarized waves of the double circularly polarized waves radiated from the circularly polarized antenna, as well as the realized gain 1220 of left-handed polarized waves, have a value of at least 16.5 dB at 5.3 GHz, which is possibly the center frequency. The axial ratio 1310 of right-handed polarized waves of the double circularly polarized waves radiated from the circularly polarized antenna, as well as the axial ratio 1320 of left-handed polarized waves, have a value of at most 1.5 dB at 5.3 GHz, which is possibly the center frequency. As such, left-handed polarized waves and right-handed polarized waves of double circularly polarized waves radiated from the circularly polarized antenna, which has a plurality of conductive structures arranged on the superstrate of the feed antenna, improve the gain and axial ratio of the antenna. A process of manufacturing a circularly polarized antenna in accordance with an embodiment of the present invention will now be described in more detail with reference to FIG. 14.

FIG. 14 schematically illustrates a process of manufacturing a circularly polarized antenna in a wireless communication system in accordance with an embodiment of the present invention.

Referring to FIG. 14, a plurality of conductive structures, specifically a plurality of patches, are formed on a dielectric substrate having a predetermined dielectric constant at step S1410. The plurality of conductive structures are arranged in a predetermined direction, and are formed by removing symmetric corners, which face each other in the diagonal direction, of quadrilateral patches to be parallel to each other so that, when linearly polarized waves are fed, circularly polarized waves are generated and radiated. The plurality of conductive structures may have various sizes and shapes depending on the operating frequency, antenna gain, and polarized wave characteristics of the circularly polarized antenna. The dielectric substrate, on which the conductive structures are arranged, may have a larger size to improve antenna gain, and may have various shapes including a rectangle, a square, a circle, an ellipse, a trapezoid, etc.

When x-polarized waves are radiated and fed below the dielectric substrate, the plurality of conductive structures and the dielectric substrate serve as a circularly polarized antenna radiating left-handed polarized waves. When y-polarized waves are radiated and fed below the dielectric substrate, the plurality of conductive structures and the dielectric substrate serve as a circularly polarized antenna radiating right-handed polarized waves. That is, instead of separate feeds corresponding to respective conductive structures, a small number of feeds are used to enable the plurality of conductive structures and the dielectric substrate to radiate circularly polarized waves. This simplifies the structure of the implemented circularly polarized antenna. Furthermore, during feeding, not only the dielectric substrate, but also the plurality of conductive structures arranged on the dielectric substrate, radiate circularly polarized waves, thereby improving antenna gain.

The position and number of feed antennas, which are to be used to feed the dielectric substrate and the plurality of conductive structures arranged on the dielectric substrate, are determined at step S1420. Specifically, the position and number of feed antennas are determined based on consideration of whether the dielectric substrate and the plurality of conductive structures arranged on the dielectric substrate are to radiate left-handed polarized waves, right-handed polarized waves, or double circularly polarized waves.

When the dielectric substrate and the plurality of conductive structures arranged on the dielectric substrate are to radiate left-handed polarized waves or right-handed polarized waves, it is determined to form a single feed antenna at a predetermined distance from below the dielectric substrate (i.e. superstrate), on which the plurality of conductive structures are arranged, so as to have a feed point at a predetermined distance from the center point below the dielectric substrate as illustrated in FIG. 4, i.e. a single feed antenna is formed on a single dielectric substrate, so that x-polarized waves or y-polarized waves are radiated through a first or second feed. The dielectric substrate, on which the single feed antenna is formed, is formed on a ground substrate, and has a y-axis length smaller than or larger than its x-axis length.

When the dielectric substrate and the plurality of conductive structures arranged on the dielectric substrate are to radiate double circularly polarized waves, it is determined to form first and second feed antennas at a predetermined distance from below the dielectric substrate (i.e. superstrate), on which the plurality of conductive structures are arranged, to have feed points at a predetermined distance along the y-axis and x-axis from the center point below the dielectric substrate, respectively, as illustrated in FIG. 5, i.e. first and second feed antennas are formed on a single dielectric substrate, which is formed on a ground substrate, so that x-polarized waves and y-polarized waves are radiated.

When the dielectric substrate and the plurality of conductive structures arranged on the dielectric substrate are to radiate double circularly polarized waves, it may be determined to form first and second feed antennas on two corresponding dielectric substrates, respectively, which are formed on a ground substrate, so as to radiate x-polarized waves and y-polarized waves as illustrated in FIG. 6. The first feed antenna is determined to have a feed point at a predetermined distance from the center point of a dielectric substrate, which has a y-axis length larger than its x-axis length, and the second feed antenna is determined to have a feed point at a predetermined distance from the center point of a dielectric substrate, which has a y-axis length smaller than its x-axis length.

Based on the position and number of feed antennas determined at the previous step, feed antennas are formed on a dielectric substrate on a ground substrate, which is positioned at a predetermined distance (h) from below the dielectric substrate, on which the plurality of conductive structures are arranged, at step S1430. Specifically, when a single feed antenna has been determined so that the dielectric substrate and the plurality of conductive structures arranged on the dielectric substrate radiate left-handed polarized waves or right-handed polarized waves, a single feed antenna is formed to have a feed point at a predetermined distance from the center point of a dielectric substrate, which is formed on the ground substrate, and which has a y-axis length smaller than or larger than its x-axis length. The dielectric substrate, on which the plurality of conductive structures are arranged, acts as a superstrate of the feed antenna.

When the dielectric substrate has a y-axis length smaller than its x-axis length, the feed antenna radiates x-polarized waves, which are fed, so that the plurality of conductive structures and the dielectric substrate, on which the plurality of conductive structures are arranged, radiate left-handed polarized waves. When the dielectric substrate has a y-axis length larger than its x-axis length, the feed antenna radiates y-polarized waves, which are fed, so that the plurality of conductive structures and the dielectric substrate, on which the plurality of conductive structures are arranged, radiate right-handed polarized waves.

When it has been determined to form two feed antennas on a single dielectric substrate so that the dielectric substrate and the plurality of conductive structures arranged on the dielectric substrate radiate double circularly polarized waves, first and second feed antennas are formed to have feed points at a predetermined distance along the y-axis and x-axis from the center point of a dielectric substrate, which is formed on a ground substrate, respectively. The dielectric substrate, on which the plurality of conductive structures are arranged, acts as a superstrate of the first and second feed antennas.

The first feed antenna radiates y-polarized waves, which are fed, so that the plurality of conductive structures and the dielectric substrate, on which the plurality of conductive structures are arranged, radiate right-handed polarized waves. The second feed antenna radiates x-polarized waves, which are fed, so that the plurality of conductive structures and the dielectric substrate, on which the plurality of conductive structures are arranged, radiate left-handed polarized waves. As such, the plurality of conductive structures and the dielectric substrate, on which the plurality of conductive structures are arranged, radiate left-handed polarized waves and right-handed polarized waves, i.e. double circularly polarized waves.

When it has been determined to form two feed antennas on two corresponding dielectric substrates, respectively, so that the dielectric substrate and the plurality of conductive structures arranged on the dielectric substrate radiate double circularly polarized waves, a first feed antenna is formed on a dielectric substrate, which is formed on a ground substrate, and which has a y-axis length larger than its x-axis length, and a second feed antenna is formed on a dielectric substrate, which has a y-axis length smaller than its x-axis length. The first and second feed antennas are formed to have feed points at a predetermined distance from the center point of the dielectric substrates, respectively. The dielectric substrate, on which the plurality of conductive structures are arranged, acts as a superstrate of the first and second feed antennas.

The first feed antenna radiates y-polarized waves, which are fed, so that the plurality of conductive structures and the dielectric substrate, on which the plurality of conductive structures are arranged, radiate right-handed polarized waves. The second feed antenna radiates x-polarized waves, which are fed, so that the plurality of conductive structures and the dielectric substrate, on which the plurality of conductive structures are arranged, radiate left-handed polarized waves. As such, the plurality of conductive structures and the dielectric substrate, on which the plurality of conductive structures are arranged, radiate left-handed polarized waves and right-handed polarized waves, i.e. double circularly polarized waves.

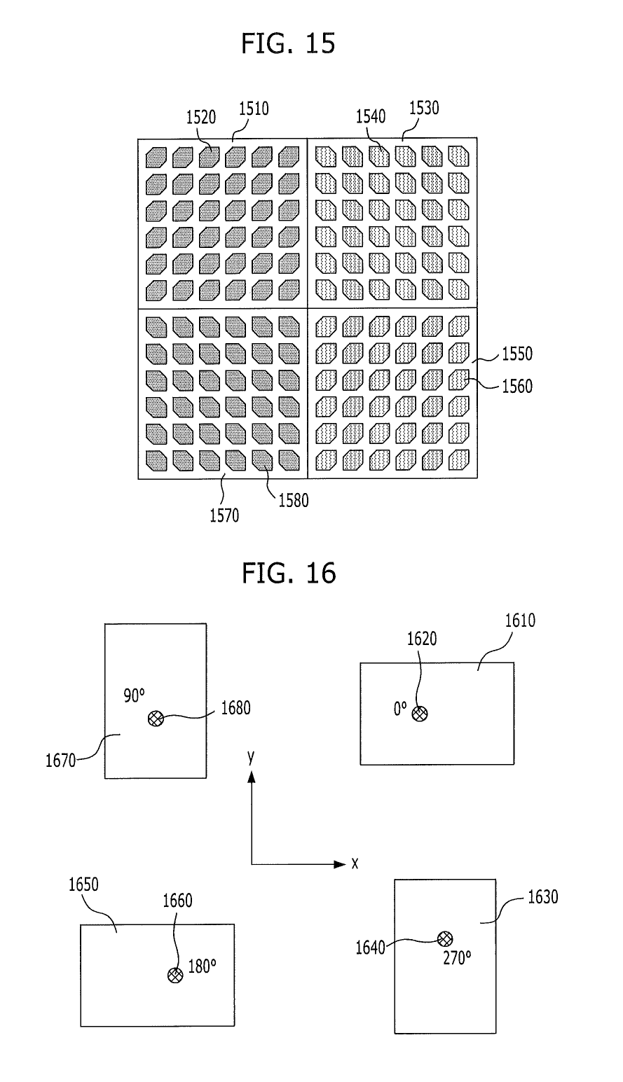

The dielectric substrate, on which the plurality of conductive structures are formed, is coupled to at least one dielectric substrate, on which at least one feed antenna is formed, to form a circularly polarized antenna which radiates left-handed polarized waves, right-handed polarized waves, or double circularly polarized waves including left-handed polarized waves and right-handed polarized waves at step S1440. Arrangement of a circularly polarized antenna in accordance with another embodiment of the present invention will now be described in more detail with reference to FIG. 15.

FIG. 15 schematically illustrates an arrayed antenna structure of a circularly polarized antenna in a wireless communication system in accordance with another embodiment of the present invention. Specifically, FIG. 15 illustrates an arrayed antenna of a circularly polarized antenna obtained by successively arranging superstrates of unit antennas in accordance with another embodiment of the present invention.

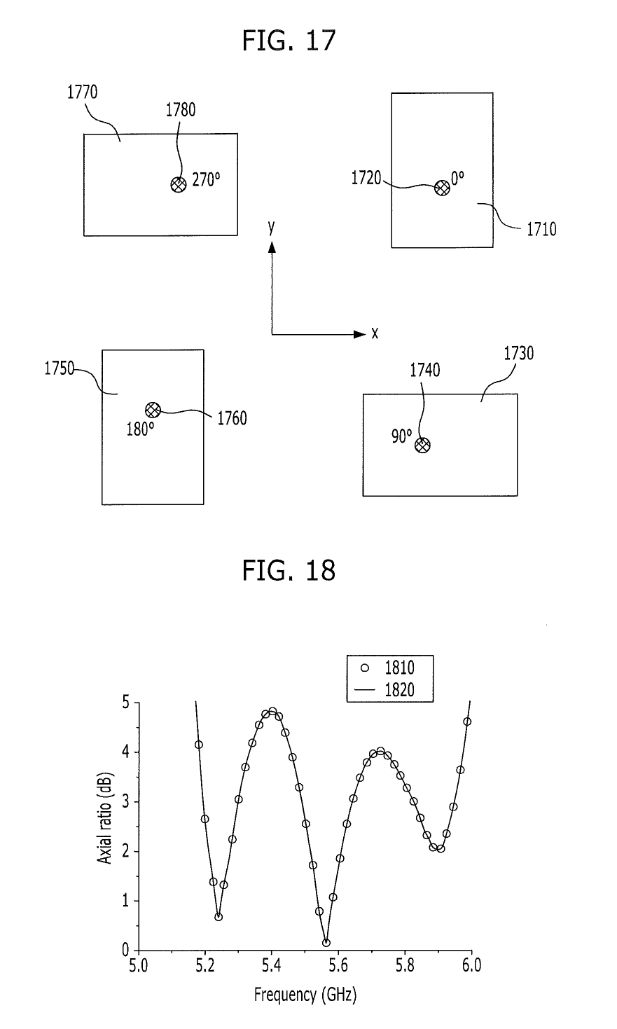

Referring to FIG. 15, the arrayed antenna of the circularly polarized antenna has two types of arrays, specifically first and second arrays, depending on the type of arrangement of the unit antennas. The first and second arrays will be described in more detail with reference to FIGS. 16 and 17, respectively.

The arrayed antenna is formed by rotating superstrates 1510, 1530, 1550, and 1570 of a plurality of unit antennas as much as 0°, 90°, 180°, and 270°, respectively, clockwise or counterclockwise with reference to the superstrate 1530 of the first unit antenna, on which a plurality of conductive structures 1540 (i.e. patches) are arranged. The superstrates 1510, 1530, 1550, and 1570 of the plurality of unit antennas have a plurality of conductive structures 1520, 1540, 1560, and 1580 arranged thereon, respectively.

The arrayed antenna, which is formed by rotating superstrates 1510, 1530, 1550, and 1570 of a plurality of unit antennas clockwise or counterclockwise, has the same shape as illustrated in FIG. 15, and radiates right-handed polarized waves or left-handed polarized waves. That is, the arrayed antenna acts as a circularly polarized antenna radiating left-handed polarized waves or right-handed polarized waves depending on the successive arrangement of feeds of feed antennas included in the unit antennas, i.e. first or second feeds. Arrayed antennas of a circularly polarized antenna in accordance with another embodiment of the present invention will now be described in more detail with reference to FIGS. 16 and 17.

FIGS. 16 and 17 schematically illustrate the arrangement structure of arrayed antennas of a circularly polarized antenna in a wireless communication system in accordance with another embodiment of the present invention. Specifically, FIG. 16 illustrates an arrayed antenna formed by first arrangement of unit antennas in accordance with another embodiment of the present invention, and FIG. 17 illustrates an arrayed antenna formed by second arrangement of unit antennas in accordance with another embodiment of the present invention.

Referring to FIG. 16, the arrayed antenna is formed by rotating four unit antennas 1610, 1630, 1650, and 1670, which radiate left-handed polarized waves when x-polarized waves are fed through the second feed 450, counterclockwise or clockwise. In other words, successive arrangement of first unit antennas 1610, which radiate left-handed polarized waves through the second feed 450, at 0°, 90°, 180°, and 270° forms a first arrayed antenna, which radiates left-handed polarized waves. Respective unit antennas 1610, 1630, 1650, and 1670 of the arrayed antenna have phase differences of 0°, 90°, 180°, and 270° with reference to the first unit antenna 1610.

The arrayed antenna acts as a circularly polarized antenna radiating left-handed polarized waves, and respective unit antennas 1610, 1630, 1650, and 1670 radiate left-handed polarized waves by means of feeds of respective feed antennas 1620, 1640, 1660, and 1680 which radiate x-polarized waves. As a result, the plurality of conductive structures arranged on the superstrates of respective unit antennas 1610, 1630, 1650, and 1670, which constitute the arrayed antenna, radiate circularly polarized waves, respective unit antennas 1610, 1630, 1650, and 1670 radiate circularly polarized waves, and the arrayed antenna itself radiates circularly polarized waves. Consequently, the arrayed antenna is regarded as a circularly polarized antenna having high gain, but simple structure, by using a small number of feed antennas.

Referring to FIG. 17, the arrayed antenna is formed by rotating four unit antennas 1710, 1730, 1750, and 1770, which radiate right-handed polarized waves when y-polarized waves are fed through the first feed 400, counterclockwise or clockwise. In other words, successive arrangement of first unit antennas 1710, which radiate right-handed polarized waves through the first feed 400, at 0°, 90°, 180°, and 270° forms a second arrayed antenna, which radiates right-handed polarized waves. Respective unit antennas 1710, 1730, 1750, and 1770 of the arrayed antenna have phase differences of 0°, 90°, 180°, and 270° with reference to the first unit antenna 1710.

The arrayed antenna acts as a circularly polarized antenna radiating right-handed polarized waves, and respective unit antennas 1710, 1730, 1750, and 1770 radiate right-handed polarized waves by means of feeds of respective feed antennas 1720, 1740, 1760, and 1780 which radiate y-polarized waves. As a result, the plurality of conductive structures arranged on the superstrates of respective unit antennas 1710, 1730, 1750, and 1770, which constitute the arrayed antenna, radiate circularly polarized waves, respective unit antennas 1710, 1730, 1750, and 1770 radiate circularly polarized waves, and the arrayed antenna itself radiates circularly polarized waves. Consequently, the arrayed antenna is regarded as a circularly polarized antenna having high gain, but simple structure, by using a small number of feed antennas. The gain and axial ratio of a circularly polarized antenna implemented by successive arrangement in accordance with an embodiment of the present invention will now be described in more detail with reference to FIGS. 18 to 21.

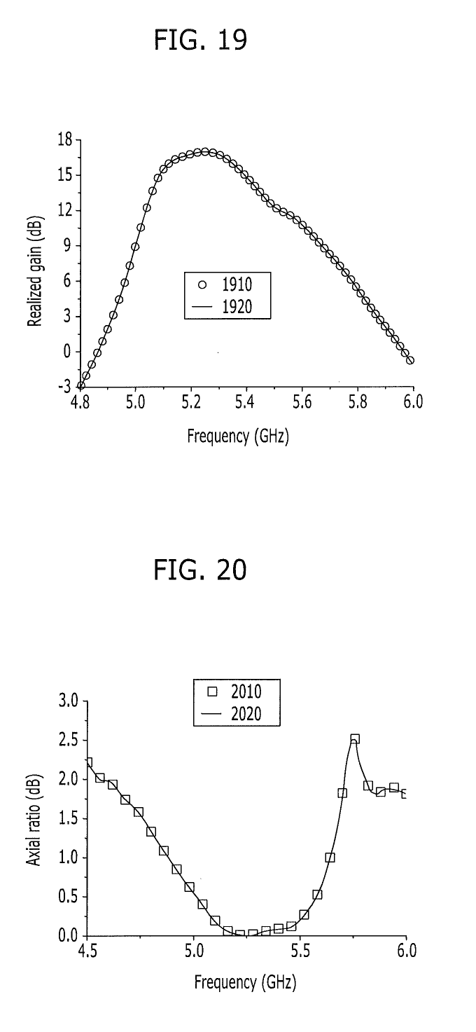

FIGS. 18 and 19 are graphs showing the axial ratio and gain of a unit antenna of a circularly polarized antenna in a wireless communication system in accordance with another embodiment of the present invention. Specifically, FIG. 18 is a frequency-domain graph showing the axial ratio of left-handed polarized waves and right-handed polarized waves radiated from the unit antenna in accordance with another embodiment of the present invention, and FIG. 19 is a frequency-domain graph showing the realized gain of left-handed polarized waves and right-handed polarized waves radiated from the unit antenna in accordance with another embodiment of the present invention.

Referring to FIGS. 18 and 19, the antenna axial ratio 1810 of right-handed polarized waves radiated from the unit antenna, as well as the antenna axial ratio 1820 of left-handed polarized waves, are 0.5 dB at 5.24 GHz, and have a 3 dB axial-ratio bandwidth of 2.4%. The realized gain 1910 of right-handed polarized waves radiated from the unit antenna, as well as the realized gain 1920 of left-handed polarized waves, are 17.05 dB at 5.24 GHz, which is the center frequency, and have a 3 dB bandwidth of 6.8%.

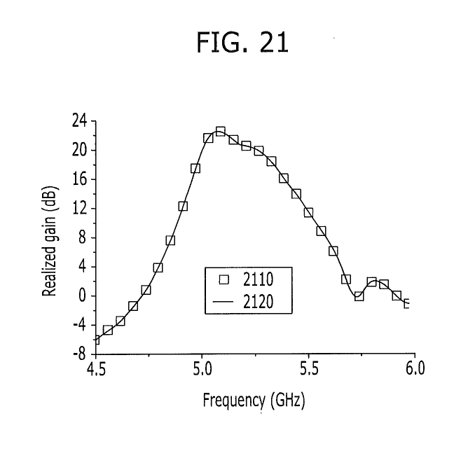

FIGS. 20 and 21 are graphs showing the axial ratio and gain of an arrayed antenna of a circularly polarized antenna in a wireless communication system in accordance with another embodiment of the present invention. Specifically, FIG. 20 is a frequency-domain graph showing the axial ratio of left-handed polarized waves and right-handed polarized waves radiated from the arrayed antenna in accordance with another embodiment of the present invention, and FIG. 21 is a frequency-domain graph showing the realized gain of left-handed polarized waves and right-handed polarized waves radiated from the arrayed antenna in accordance with another embodiment of the present invention.

Referring to FIGS. 20 and 21, the antenna axial ratio 2010 of right-handed polarized waves radiated from the arrayed antenna, as well as the antenna axial ratio 2020 of left-handed polarized waves, are 0.005 dB at 5.24 GHz, and have a 3 dB axial-ratio bandwidth of at least 28%. The realized gain 2110 of right-handed polarized waves radiated from the arrayed antenna, as well as the realized gain 2120 of left-handed polarized waves, are 22.61 dB at 5.1 GHz, and have a 3 dB bandwidth of 5.7%.

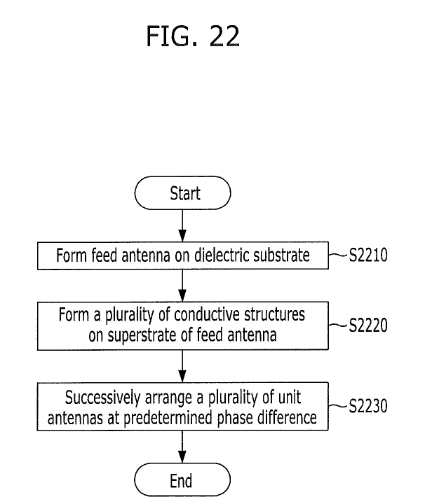

As such, the arrayed antenna, which includes successively arranged unit antennas, has improved antenna gain, axial ratio, and 3 dB axial-ratio bandwidth. More specifically, the circularly polarized antenna in accordance with another embodiment of the present invention employs arrangement different from that of conventional patch-based arrayed antennas, so that the gain of respective unit antennas is higher than that of patch antennas. As a result, a small number of feed antennas are used to acquire a high-gain circularly polarized antenna. In other words, conventional patch antennas have gain of 6 dB, and arrangement of at least 64 patch antennas is necessary to acquire antenna gain of 24 dB. In contrast, the circularly polarized antenna in accordance with another embodiment of the present invention has unit antenna gain of 17 dB, and arrangement four such unit antennas gives high antenna gain of 22.6 dB. More specifically, the circularly polarized antenna in accordance with another embodiment of the present invention has a single feed antenna configured to feed respective antennas radiating circularly polarized waves, i.e. unit antennas, which have gain of 17.05 dB. Therefore, successive arrangement of only four unit antennas easily implements an arrayed antenna having high gain of 22.61 dB. A process of manufacturing a circularly polarized antenna based on successive arrangement in accordance with another embodiment of the present invention will now be described in more detail with reference to FIG. 22.

FIG. 22 schematically illustrates a process of manufacturing a circularly polarized antenna in a wireless communication system in accordance with another embodiment of the present invention.

Referring to FIG. 22, a single feed antenna is formed on a dielectric substrate formed on a ground substrate at step S2210. Specifically, the feed antenna is formed to have a feed point at a predetermined distance from the center point of the dielectric substrate. Based on the feed point, a first feed 400 or a second feed 450 is determined, so that the feed antenna radiates x-polarized waves or y-polarized waves accordingly.

A plurality of conductive structures, specifically a plurality of patches, are formed on a dielectric substrate (i.e. superstrate) positioned at a predetermined distance (h) from above a ground substrate, on which a dielectric substrate and a feed antenna are formed, at step S2220. The plurality of conductive structures are arranged in a predetermined direction, and are formed by removing symmetric corners, which face each other in the diagonal direction, of quadrilateral patches to be parallel to each other so that, when linearly polarized waves are fed, circularly polarized waves are generated and radiated. The plurality of conductive structures may have various sizes and shapes depending on the operating frequency, antenna gain, and polarized wave characteristics of the circularly polarized antenna. The superstrate may have a larger size to improve antenna gain, and may have various shapes including a rectangle, a square, a circle, an ellipse, a trapezoid, etc.

When the feed antenna radiates x-polarized waves and feeds them to the superstrate, the plurality of conductive structures and the superstrate serve as a circularly polarized antenna radiating left-handed polarized waves. When the feed antenna radiates y-polarized waves and feeds them to the superstrate, the plurality of conductive structures and the superstrate serve as a circularly polarized antenna radiating right-handed polarized waves. That is, the single feed antenna and the superstrate of the feed antenna, on which the plurality of conductive structures are formed, constitute a unit antenna, which acts as a circularly polarized antenna. The fact that the single feed antenna feeds the plurality of conductive structures simplifies antenna structure. During feeding, not only the superstrate, but also the plurality of conductive structures arranged on the superstrate, radiate circularly polarized waves, thereby improving antenna gain.

A plurality of unit antennas formed as described above are rotated to have a predetermined phase difference at step S2230, e.g. four unit antennas are rotated as much as 0°, 90°, 180°, and 270°, respectively, clockwise or counterclockwise so that, with reference to one of them, four of the unit antennas are successively arranged at 0°, 90°, 180°, and 270°. Such successive arrangement of a plurality of unit antennas so as to have a predetermined phase difference forms an arrayed antenna, which radiates left-handed polarized waves or right-handed polarized waves depending on feeding of feed antennas included in respective unit antennas.

In other words, an arrayed antenna formed by successively arranging a plurality of unit antennas, which include feed antennas radiating x-polarized waves, respectively, acts as a circularly polarized antenna radiating left-handed polarized waves. Likewise, an arrayed antenna formed by successively arranging a plurality of unit antennas, which include feed antennas radiating y-polarized waves, respectively, acts as a circularly polarized antenna radiating right-handed polarized waves. When x-polarized waves are fed, not only the arrayed antenna and the plurality of unit antennas, but also the plurality of conductive structures included in the plurality of unit antennas radiate left-handed polarized waves. Similarly, when y-polarized waves are fed, not only the arrayed antenna and the plurality of unit antennas, but also the plurality of conductive structures included in the plurality of unit antennas radiate right-handed polarized waves. The fact that a small number of feed antennas are sued for feeding simplifies antenna structure. During feeding, not only the arrayed antenna and the plurality of superstrates constituting the arrayed antenna, but also the plurality of conductive structures arranged on the plurality of superstrates, radiate circularly polarized waves, thereby improving antenna gain.

In accordance with the exemplary embodiments of the present invention, a circularly polarized antenna is easily implemented in a wireless communication system by using a superstrate, patch antennas, and a small number of feed antennas so as to have high gain while guaranteeing simple antenna structure, and so is an array of such circularly polarized antennas. The circularly polarized antenna can be easily implemented using a PCB. Positioning the conductive structures on the upper portion of the antenna makes it possible to design a circularly polarized antenna using a single feed antenna (source), and improves the antenna's efficiency and gain.

Depending on characteristics of linearly polarized waves radiated from the feed antenna, a left-handed polarized wave antenna, a right-handed polarized wave antenna, or a double circularly polarized wave antenna can be easily implemented. The present invention has a simpler feed structure, compared with conventional circularly polarized arrayed antennas, to acquire high gain. This minimizes design complexity of the circularly polarized antenna and antenna supply power loss, and maximizes antenna efficiency.

The fact that a plurality of patches (i.e. conductive structures) are positioned on the upper portion of the antenna makes it possible to implement a circularly polarized antenna using a single feed antenna (source), thereby improving both efficiency and gain of the antenna. Successive arrangement of high-gain circularly polarized antennas designed in this manner improves the antenna gain, axial ratio, and 3 dB axial-ratio bandwidth. The resulting feed structure is simpler than in the case of conventional high-gain circularly-polarized successively-arranged antennas, thereby minimizing antenna design complexity.

The present invention also minimizes antenna supply power loss and thus improves antenna efficiency. In the case of conventional successively arranged antennas, the gain of respective patch antennas constituting the successively arranged antennas is about 6 dB, which means that 64 individual antennas are necessary to obtain high gain of 24 dB. In accordance with the present invention, to the contrary, individual antennas have gain of 17.05 dB, which means that successive arrangement of only four unit antennas implements high gain of 22.61 dB, also improving the axial ratio and 3 dB axial-ratio bandwidth.

While the present invention has been described with respect to the specific embodiments, it will be apparent to those skilled in the art that various changes and modifications may be made without departing from the spirit and scope of the invention as defined in the following claims.

What is claimed is:

1. A circularly polarized antenna in a wireless communication system, comprising:
at least one feed antenna positioned at a predetermined point on at least one ground substrate; and
a unit antenna having a plurality of conductive structures arranged in a predetermined identical direction on a superstrate positioned at a predetermined distance from above the feed antenna, wherein
the plurality of conductive structures and the unit antenna are configured to radiate circularly polarized waves, respectively, when the feed antenna radiates linearly polarized waves.

2. The circularly polarized antenna of claim 1, wherein the plurality of conductive structures and the unit antenna are configured to radiate left-handed polarized waves, respectively, when the feed antenna radiates x-polarized waves.

3. The circularly polarized antenna of claim 2, wherein the x-polarized waves are radiated from a feed antenna having a feed point at a predetermined distance from a center point on the ground substrate shaped to have a y-axis length smaller than an x-axis length.

4. The circularly polarized antenna of claim 2, wherein the circularly polarized antenna comprises an arrayed antenna having a plurality of unit antennas successively arranged to have a phase difference of 0°, 90°, 180°, and 270°, the unit antennas comprising feed antennas configured to radiate the x-polarized waves, and
the plurality of unit antennas and the arrayed antenna are configured to radiate the left-handed polarized waves, respectively.

5. The circularly polarized antenna of claim 1, wherein the plurality of conductive structures and the unit antenna are configured to radiate right-handed polarized waves, respectively, when the feed antenna radiates y-polarized waves.

6. The circularly polarized antenna of claim 5, wherein the y-polarized waves are radiated from a feed antenna having a feed point at a predetermined distance from a center point on the ground substrate shaped to have a y-axis length larger than an x-axis length.

7. The circularly polarized antenna of claim 5, wherein the circularly polarized antenna comprises an arrayed antenna having a plurality of unit antennas successively arranged to have a phase difference of 0°, 90°, 180°, and 270°, the unit antennas comprising feed antennas configured to radiate the y-polarized waves, and
the plurality of unit antennas and the arrayed antenna are configured to radiate the right-handed polarized waves, respectively.

8. The circularly polarized antenna of claim 1, wherein the plurality of conductive structures and the unit antenna are configured to radiate left-handed polarized waves and right-handed polarized waves, respectively, when at least two feed antennas formed on a first ground substrate of the at least one ground substrate radiates x-polarized waves and y-polarized waves, respectively.

9. The circularly polarized antenna of claim 8, wherein the y-polarized waves are radiated from a first feed antenna having a feed point at a predetermined distance along y-axis from a center point on the first ground substrate, and
the x-polarized waves are radiated from a second feed antenna having a feed point at a predetermined distance along x-axis from the center point on the first ground substrate.

10. The circularly polarized antenna of claim 1, wherein the plurality of conductive structures and the unit antenna are configured to radiate left-handed polarized waves and right-handed polarized waves, respectively, when a first feed antenna formed on a first ground substrate of the at least one ground substrate and a second feed antenna formed on a second ground substrate radiate x-polarized waves and y-polarized waves, respectively.

11. The circularly polarized antenna of claim 10, wherein the first ground substrate is shaped to have a y-axis length larger than an x-axis length, and the first feed antenna has a feed point at a predetermined distance from a center point on the first ground substrate so as to radiate the y-polarized waves.

12. The circularly polarized antenna of claim 10, wherein the second ground substrate is shaped to have a y-axis length smaller than an x-axis length, and the second feed antenna has a feed point at a predetermined distance from a center point on the second ground substrate so as to radiate the x-polarized waves.

13. The circularly polarized antenna of claim 1, wherein the plurality of conductive structures are shaped by removing symmetric corners of quadrilateral patches, the symmetric corners facing each other in a diagonal direction, to be parallel to each other.

14. The circularly polarized antenna of claim 1, wherein the plurality of conductive structures are configured to receive the linearly polarized waves indirectly fed from the feed antenna and radiate different circularly polarized waves corresponding to the indirectly fed linearly polarized waves.

15. The circularly polarized antenna of claim 1, wherein the plurality of conductive structures have a size and a shape determined based on an operating frequency, antenna gain, and polarized wave characteristics of the circularly polarized antenna.

16. A method for manufacturing a circularly polarized antenna in a wireless communication system, comprising:
arranging a plurality of conductive structures in a predetermined identical direction on a first dielectric substrate positioned at a predetermined distance from above a ground substrate; and
forming a feed antenna at a predetermined point on the ground substrate so that the feed antenna has a feed point at a predetermined distance from a center point on the ground substrate, wherein
when the ground substrate is shaped to have a y-axis length larger than an x-axis length, the feed antenna radiates y-polarized waves, and the dielectric substrate and the plurality of conductive structures radiate right-handed polarized waves, respectively, and
when the ground substrate is shaped to have a y-axis length smaller than an x-axis length, the feed antenna radiates x-polarized waves, and the dielectric substrate and the plurality of conductive structures radiate left-handed polarized waves, respectively.

17. The method of claim 16, wherein, in said arranging a plurality of conductive structures in a predetermined identical direction on a first dielectric substrate positioned at a predetermined distance from above a ground substrate,
the plurality of conductive structures are formed and shaped by removing symmetric corners of quadrilateral patches, the symmetric corners facing each other in a diagonal direction, to be parallel to each other.

18. The method of claim 16, wherein, in said forming a feed antenna at a predetermined point on the ground substrate so that the feed antenna has a feed point at a predetermined distance from a center point on the ground substrate,
a first feed antenna is formed at a predetermined point on the ground substrate so as to have a feed point at a predetermined distance along y-axis from a center point on the ground substrate, and a second feed antenna is formed at a predetermined point on the ground substrate so as to have a feed point at a predetermined distance along x-axis from the center point on the ground substrate;
the y-polarized waves are radiated from the first feed antenna so that the dielectric substrate and the plurality of conductive structures radiate the right-handed polarized waves, respectively; and
the x-polarized waves are radiated from the second feed antenna so that the dielectric substrate and the plurality of conductive structures radiate the left-handed polarized waves, respectively.

19. The method of claim 16, wherein, in said forming a feed antenna at a predetermined point on the ground substrate so that the feed antenna has a feed point at a predetermined distance from a center point on the ground substrate,
a first feed antenna is formed at a predetermined point on a second dielectric substrate, the second dielectric substrate being positioned on the ground substrate and shaped to have a y-axis length larger than an x-axis length, so as to have a feed point at a predetermined distance from a center point on the second dielectric substrate, and a second feed antenna is formed at a predetermined point on a third dielectric substrate, the third dielectric substrate being positioned on the ground substrate and shaped to have a y-axis length smaller than an x-axis length, so as to have a feed point at a predetermined distance from a center point on the third dielectric substrate;
the y-polarized waves are radiated from the first feed antenna so that the first dielectric substrate and the plurality of conductive structures radiate the right-handed polarized waves, respectively; and
the x-polarized waves are radiated from the second feed antenna so that the first dielectric substrate and the plurality of conductive structures radiate the left-handed polarized waves, respectively.

20. A method for manufacturing a circularly polarized antenna in a wireless communication system, comprising:
forming a first dielectric substrate on a ground substrate;
forming a feed antenna at a predetermined point on the first dielectric substrate;
positioning a second dielectric substrate at a predetermined distance from the ground substrate over the feed antenna;
arranging a plurality of conductive structures on the second dielectric substrate in a predetermined identical direction, the conductive structures being shaped by removing symmetric corners of quadrilateral patches to be parallel to each other, the symmetric corners facing each other in a diagonal direction; and
successively arranging a plurality of second dielectric substrates so as to have a predetermined phase difference, the plurality of conductive structures being arranged on the second dielectric substrates, wherein
when the feed antenna radiates x-polarized waves, the plurality of conductive structures, the second dielectric substrate on which the plurality of conductive structures are arranged, and the plurality of successively arranged second dielectric substrates radiate left-handed polarized waves, respectively;
when the feed antenna radiates y-polarized waves, the plurality of conductive structures, the second dielectric substrate on which the plurality of conductive structures are arranged, and the plurality of successively arranged second dielectric substrates radiate right-handed polarized waves, respectively;
in said successively arranging a plurality of second dielectric substrates so as to have a predetermined phase difference, the plurality of conductive structures being arranged on the second dielectric substrates, a plurality of second dielectric substrates positioned over the feed antenna configured to radiate the x-polarized waves or the y-polarized waves are arranged successively so as to have a phase difference of 0°, 90°, 180°, and 270°; and
in said forming a feed antenna at a predetermined point on the first dielectric substrate, the feed antenna configured to radiate the x-polarized waves or the y-polarized waves is formed at a predetermined point on the first dielectric substrate so as to have a feed point at a predetermined distance from a center point on the first dielectric substrate shaped to have a y-axis length different from an x-axis length.
